(19) United States
(12) Patent Application Publication
(10) Pub. No.: US 2024/0377264 A1
(43) Pub. Date: Nov. 14, 2024

(54) Temperature Monitoring and Indicator Label System for Beverage Containers

(71) Applicants: Alison Cary Eldred, Spokane Valley, WA (US); Timothy Stuart Lunceford, Spokane Valley, WA (US)

(72) Inventors: Alison Cary Eldred, Spokane Valley, WA (US); Timothy Stuart Lunceford, Spokane Valley, WA (US)

(21) Appl. No.: 18/660,659

(22) Filed: May 10, 2024

Related U.S. Application Data
(60) Provisional application No. 63/465,803, filed on May 11, 2023.

(51) Int. Cl. G01K 11/16; G09F 3/00; G09F 3/02

(52) U.S. Cl. CPC G01K 11/16; G09F 3/0294; G09F 2003/0211; G09F 2003/0273

(57) ABSTRACT

Disclosed is a temperature monitoring and indicator system which monitors and detects the temperature of a beverage within a beverage container such as wine within a wine bottle, and then indicates or notifies the user where the temperature lies relative to an optimal temperature range for that particular beverage or wine.

### CROSS REFERENCE TO RELATED APPLICATION

This application claims priority from U.S. Provisional Application Ser. No. 63/465,803, filed on or about May 11, 2023, which is hereby incorporated by reference.

### TECHNICAL FIELD

This invention pertains to a temperature monitoring and indicator label system for beverage containers, including without limitation, for wine containers such as bottles.

### BACKGROUND OF THE INVENTION

Since at least as early as the day described in John 2:7-10, when Jesus turned the water into wine for a wedding, mankind has been working toward making better wine and the improvement of the presentation or serving of the wine. In one example of one embodiment of this invention as applied to wine, this invention takes one significant step forward toward the better storage, presentation and/or serving of wine within the desired or proper temperature range for that particular wine.

There are countless types and blends of beverages such as wine, and with each, there are optimal temperature ranges within which they should be served for optimal taste and experience. Much wine is stored in wine cellars, wine refrigerators and even at room temperature—which often means it is stored at temperatures outside the optimal or desired temperature range. Until now there has not been an easy way to determine if and when the wine is within an optimal temperature range for serving. It is further known that with so many different types and varieties of wine (white wine, red wine, blends and countless varieties thereof), each may and often does have its own optimal temperature range. It shall be noted that while the primary reference used herein for a beverage and beverage container is that of wine and a wine bottle, this invention is not so limited and may be applied to other beverages and other types of containers, all within the scope of different embodiments of this invention.

While there have been attempts to monitor, measure and give an indicator of whether a beverage such as beer is at a suitably low temperature, there has not heretofore been such a solution to monitor and indicate whether a beverage such as wine is within an optimal range, i.e. not too high a temperature and not too low of a temperature.

It is desirable to conduct this monitoring and indicating of the optimal temperature range without having to open the bottle of wine and measure the temperature of the contents. It is also desirable to have temperature indicators to provide a visual notification, indicator or alert visible to the wine consumer when and if a temperature is too low, too high or in the optimal or desired range.

It is still further desirable to provide such a temperature monitoring and indicator system that is economical enough to enable it to be integral with each individual bottle of wine (or label thereof). The desirability would be enhanced if such a monitoring and indicator system were to be integrated within an existing label on the bottle, or an additional label or indicator attached to or integral with the wine bottle.

It is therefore an objective of some embodiments of this invention to provide a temperature monitoring and indicator system for a beverage container (wine bottle) which is attached to the wine bottle as part of an existing wine label, or as a separate label on the wine bottle. It will be appreciated that while typical labels are comprised of paper or fiber like substances, others may likewise be used such as resins for example (as described more fully herein).

It is also an object of some applications or embodiments of this invention to provide such a temperature monitoring and indicator system that uses indicators such as color (and changing color) to notify the user that the particular wine is in one of three temperature ranges: a temperature range below the optimal range (which indicates the wine in the bottle needs to warm before optimal serving); and optimal temperature range when the particular type of wine within the bottle is at a temperature ready for serving; and a temperature range above the optimal range (which necessarily indicates the particular wine in the bottle is at too high of a temperature for optimal serving).

It is also an object of some applications of embodiments of this invention to provide temperature monitoring and indicator systems for each type of wine and its desired optimal temperature range for serving, which this invention does so provide.

It is still further an objective of embodiments of this invention to provide such a system wherein adjustments or temperature offsets may be utilized to correlate the temperature of the beverage or wine inside the bottle to the temperature visually indicated by color on the label. This invention has the advantage of, in situations warranting it, to consider the temperature difference or delta across the cross-section of the bottle and into the beverage, to result in a more accurate monitoring and notification system. In some embodiments of this invention, this temperature differential may be in the one (1) to four (4) degree range, such as two (2) degrees fahrenheit (or Celsius).

Other objects, features, and advantages of this invention will appear from the specification, claims, and accompanying drawings which form a part hereof. In carrying out the objects of this invention, it is to be understood that its essential features are susceptible to change in design and structural arrangement, with only one practical and preferred embodiment being illustrated in the accompanying drawings, as required.

### BRIEF DESCRIPTION OF THE DRAWINGS

Preferred embodiments of the invention are described below with reference to the following accompanying drawings.

FIG. 1 is an elevation view of one example of an embodiment of this invention, illustrating a label-based temperature monitoring and indicator system on a wine bottle.

FIGS. 2, 3 and 4 are detail elevation views of examples of an embodiment of this invention in which the temperature monitoring and indicator system notifies the user of the temperature range of the wine in the bottle as too high of a temperature (FIG. 2), within an optimal temperature range for that particular wine (FIG. 3) and the temperature is too low of a temperature for that particular wine (FIG. 4).

FIG. 2 is a detail elevation view of one example of an embodiment of this invention illustrating such a temperature monitoring and indicator system wherein the system is notifying the user that the temperature range of the wine in the bottle is too high (i.e. above the optimal range for that particular wine), and optimally needs to be further chilled to the optimal temperature range before serving.

FIG. 3 is a detail elevation view of one example of an embodiment of this invention illustrating such a temperature monitoring and indicator system wherein the system is notifying the user that the temperature range of the wine in the bottle is within the optimal range for serving that particular wine.

FIG. 4 is a detail elevation view of one example of an embodiment of this invention illustrating such a temperature monitoring and indicator system wherein the system is notifying the user that the temperature range of the wine in the bottle is too low (i.e. below the optimal range for that particular wine), and needs to warm up before it can be effectively served within the optimal temperature range.

FIG. 5 is an elevation view of one example of an embodiment of this invention, illustrating two possible label-based temperature monitoring and indicator systems on a wine bottle, to illustrate different location possibilities and which may result in different temperatures being detected—i.e. a temperature differential from top to bottom.

FIG. 6 is a detail elevation cross-section of the wall of the beverage container with a label thereon, illustrating a potential temperature delta or differential to be considered in establishing the predetermined temperature settings in the label at which the visible characteristics to the user change.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

While there may be debate (or preferences) as to what the optimal temperature range is for serving or drinking a particular wine or category of wines, there is no debate that there are optimal temperature ranges for different wines. The optimal or desired temperature ranges will vary in different wine types or categories, and sometimes varies depending on which growing region the grapes were grown.

For example, a first category of wine may be that which is optimally served within a temperature range of about 45° F. to 50° F., and this category may include such wines as: Pinot Gris, Riesling, Sauvignon Blanc, sparkling wine, white Zinfandel, Chablis, ice wines, champagne, Shannon Blanc, Pinot Grigio, Semillon, Aligote, Soave, Pouilly Fuisse, and others. By further example, a second category of wine may be that which is optimally served within a temperature range of about 50° to 55° F., and this category may include such wines as: White Bordeaux blends, Chardonnay, white and ross wines, Gewurztraminer, Moschofilero, Sauternes, Beaujolais, Tawny/NV Port, Viognier, and others.

An example of a third category of wine may be that which is optimally served within a temperature range of about 55° F. to 60° F., and this category may include such wines as “Sweet Aromatic's Sparkling Wines, Cabernet Franc, Valpolicella, Madeira, Chianti, Pinot Noir, Red Burgundy, Sangiovese, Gamay, and others. Yet one more example of a fourth category of wine may be that which is optimally served at 60° F. to 65° F., and this may include wines such as: Syrah, Malbec, Cabernet Sauvignon, Rioja, Zinfandel, Bordeaux, Shiraz, Red Bordeaux Blends, Pinot Noir, Merlot, Grenache, Tempranillo, Nebbiolo, Bergerac, and others.

It will be appreciated by those of ordinary skill in the art that there are differing views on which wines are served in which optimal temperature ranges and no one in particular is required to practice different embodiments of this invention. It will also be appreciated that some in the industry may prefer a different number of categories, such as for example, three or five.

It should further be noted that while the temperature monitoring or measuring does not directly measure the temperature of the beverage or wine within the bottle, it measures and reflects the temperature of the exterior bottle surface, which is indicative of and can be correlated to the temperature of the beverage opposite the label on the interior cavity of the beverage container or wine bottle. Embodiments of the invention including this aspect are essentially measuring the external surface of the wine bottle, which has its own insulative properties—which assures the temperature reading as indicated are accurate.

It will also be appreciated by those of ordinary skill in the arts that the placement of the one or more temperature monitors and indicators, will potentially vary depending on the location of the temperature monitor and indicator relative to the beverage or wine within the container, as well as the temperature stratification within the beverage within the wine bottle. For example, the temperature at the top of the bottle when the bottle is vertical may be greater than the temperature at the bottom of the bottle due at least in part to the stratification of the beverage and/or stratification of the temperature within the beverage.

The temperature monitoring indicators, in the preferred embodiment, may be temperature sensitive inks (configured in one or more layers to achieve the desired visual effect) within a substrate such as a paper label, resin or other appropriate substrate. The temperature monitoring indicators are sensitive to specific temperatures and when the temperature of the indicator rises beyond a predetermined value, such as 45° F., a visible characteristic of the temperature indicator changes. In one example of such a change in a visible characteristic, an indicator can be set in a predetermined or desired shape such as a letter or word, and it can change color, or change from not visible to visible. The change in the visible characteristic of the indicator occurs when the temperature rises through the predetermined temperature value and when the temperature drops from above to below the predetermined temperature value.

In one example of an embodiment of this invention, thermochromatic ink may be used and said ink builds color (or gradiants) over a three (3a) to four (4) degrees Celsius activation range, and conversely may clear or reduce the color over a six (6) to eight (8) degree temperature range.

This invention, in combining at least two of these identified temperatures, combined with selecting the target temperatures, or two or more predetermined temperature values, uniquely allows for temperature range to be visibly detected and identified through the multiple visible characteristics of aspects of the different indicators.

Furthermore, it should be noted that different embodiments of this invention may have different ways of reflecting the temperature of the beverage or wine within the bottle. It will be recognized that the temperature of the indicator(s) on the label may not always be exactly the temperature of the wine just inside the wall of the bottle adjacent the indicators or labels. For example, if a container of wine is too warm and therefore placed in a cold or refrigerated area, there may be a larger differential between the temperature of the label (which is exposed to much cooler temperatures within the colder or refrigerated area).

In some embodiments of the invention and in order to approximate or achieve the desired temperature range of the wine, the critical temperature at which the label indicator changes its visible characteristic may be slightly altered or offset from the desired temperature of the wine within the bottle adjacent to that indicator. For example, if a wine bottle has a much higher starting temperature than desired and it is then placed in a cold or very cold environment to chill it, the temperature sensitive ink or other material may have its temperature set point to be offset a few degrees (one degree to four degrees as one example) from the desired temperature of the liquid wine in the container or bottle. So for a particular type of wine for example would normally be chilled to get it to the optimal temperature range, the label within the cold temperature area may be colder than the wine in the bottle and therefore the set temperature for the temperature sensitive indicator might be set lower than the desired temperature of the wine to compensate for the differential between the temperature at which the visible characteristic changes for the temperature sensitive ink or other material. If a particular wine would be stored at a colder temperature and it is desirable to place it in a warmer environment to raise the temperature to the desired or optimal serving temperature, embodiments of this invention might offset that considering the indicator temperature will be higher than that of the wine within the bottle.

In yet other embodiments of this invention, the setting of the predetermined temperature of the temperature sensitive label may be altered or amended to account for or accommodate known or projected temperature stratification differences within the liquid within the beverage container or wine bottle. While in some cases the beverage container would be left in a cool or warmer place for a sufficiently long time such that it would achieve a relatively homogenous temperature distribution vertically. However, in other situations the wine would be placed in the higher or lower temperature area for a minimal amount of time so that it can be served sooner than later, in which case one might experience stratification of the temperature. In the situations in which stratification of the temperature within the liquid wine is anticipated, the placement of the temperature sensitive wine label may be important, or in some situations the temperature at which the indicators change their visible characteristic might be altered to accommodate for stratification vis-a-vis the location of the temperature sensitive label on the bottle. For example, if a label is placed at the very top of the wine bottle near the neck and stratification of the temperature is expected, then the temperature sensitive ink might be selected to change its visible characteristic in a higher temperature to offset for the vertical distance to the middle of the liquid in the bottle of wine.

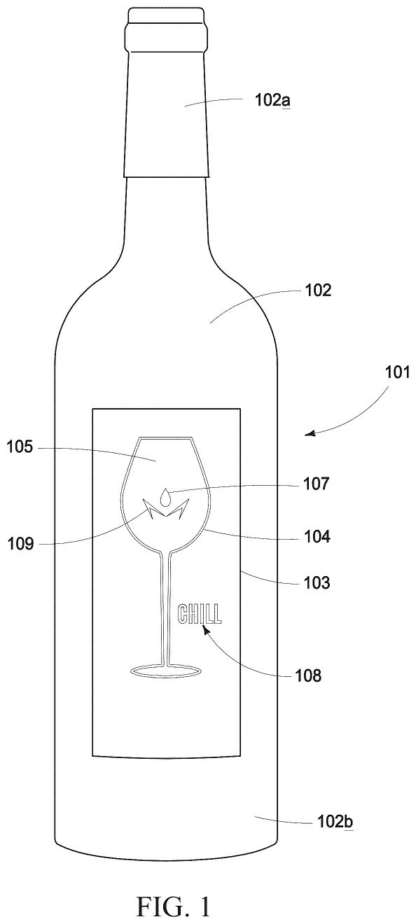

FIG. 1 is an elevation view of one example of an embodiment of this invention, illustrating a beverage container bottle with a label-based temperature monitoring and indicator system 101 on a wine bottle 102. FIG. 1 also shows an upper portion 102a of the bottle, also known as the neck of the bottle, and a lower portion 102b of the bottle.

FIG. 1 shows a label 103 with indicator images imparted thereon. The potential indicator images shown in this example of an embodiment of the invention are: an outline of a wine glass 104 with wine glass interior 105, a liquid droplet image 107, and a depiction of a crown-like image 109. Also shown in FIG. 1 is the word “chill” on the label and this would be the part of the indicator system which indicates to the user whether the temperature of the wine in the bottle is below, above or within the optimal temperature range for that particular wine. In the example shown, the word “chill” indicates that the wine in the bottle is too warm and needs to be chilled and thus the word chill is used to direct the user to further chill the bottle of wine before serving if it's desired to serve within the optimal temperature range.

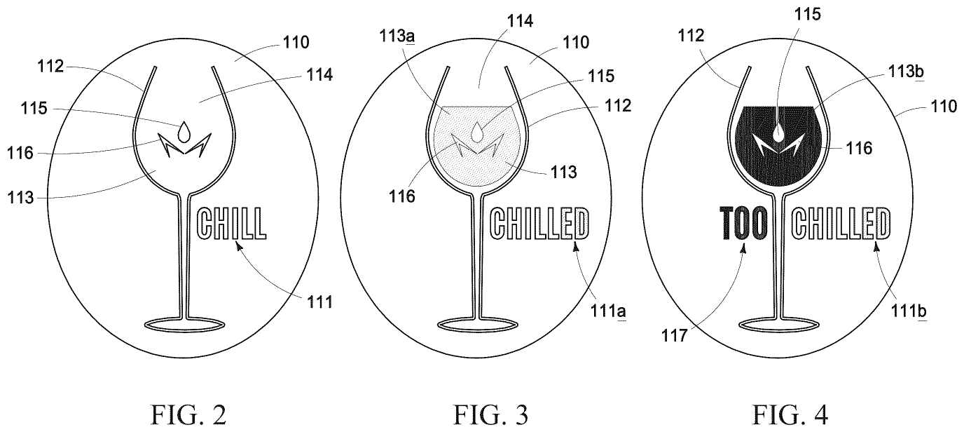

It should be noted that each of the indicator images may have a different temperature sensing capability depending on the desired application of the invention. One example shown in FIGS. 2-4 is shown more particularly in FIG. 3 as indicator 113a, which has the appearance of a liquid or beverage within the wine glass 112 (shown as hatched in the drawing). When the beverage appears as hatched within the wine glass 112, this notifies the user that the wine is in the chilled temperature range, which means the optimal temperature range for consumption.

When the term label is used herein, it means that any one of a number of different types of labels that are traditionally used on the beverage container. For wine bottles for example this will be a paper-based label with identifier and other marketing printing indicators thereon. These types of labels and the methods for affixing the labels to the bottles or beverage containers is well known by those of ordinary skill in the art and will not be detailed herein.

However, in some embodiments of this invention, a resin-based label may be used to affix to the beverage container and still provide the indicators or notifications described herein. One such example may be a silkscreen or digital print which is then covered with a resin on all or some parts thereof, with the resin being transparent and the color thereof would depend only on the substrate. One such example that may be used in embodiments of this invention is that which is supplied by Multi-Color Corporation (mcclabel.com), and is referred to as its “01320 RI-690/50 Pet Gloss White TC AP906-40 WKPE 144.

FIGS. 2, 3 and 4 are detail elevation views of examples of an embodiment of this invention in which the temperature monitoring and indicator system notifies the user of the temperature range of the wine in the bottle as too high of a temperature (FIG. 2), within an optimal temperature range for that particular wine (FIG. 3) and the temperature is too low of a temperature for that particular wine (FIG. 4).

FIG. 2 is a detail elevation view of one example of an embodiment of this invention illustrating such a temperature monitoring and indicator system 110 wherein the system is notifying the user that the temperature range of the wine in the bottle is too high (i.e. above the optimal range for that particular wine), and optimally needs to be further chilled before serving within the optimal temperature range (hence the temperature sensitive word “chill” inked on the label).

FIG. 2 illustrates a temperature monitoring and indicator system 110, illustrative wine glass 112 with top portion 114 of interior cavity, bottom portion 113 of interior cavity droplet indicator 115, crown indicator 116 and user instruction indicator 111, which is the word chill.

It should also be noted by those of ordinary skill in the art that the label or ink portion of the monitoring and indicators may be a more traditional pigment based label, or for some embodiments of this invention, may instead utilize one or more layers or types of dyes. As one example, the process in some embodiments of this invention may include combining a single hit or layer of dye (for example in the 7-8 bcm range) on a flexography type printer, with a second or double hit (in the range of 15-20 bcm) on a screen printer for the maximum effect and to achieve as clean of a transition as possible.

FIG. 3 is a detail elevation view of one example of an embodiment of this invention illustrating such a temperature monitoring and indicator system 110 wherein the system is notifying the user that the temperature range of the wine in the bottle is within the optimal range for serving that particular wine.

FIG. 3 illustrates a temperature monitoring and indicator system 110, illustrative wine glass 112 with top portion 114 of interior cavity, bottom portion 113a of interior cavity (shown shaded or with hatching to indicate or instruct the user that the beverage is within the optimal temperature range—the addition of the hatching in the bottom portion reflecting the status indicator of the wine temperature), droplet indicator 115 and crown indicator 116. In this case since the wine is within the optimal or desired temperature range, the bottom portion 113 of the internal cavity of the wine glass 112 is shaded or hatched as shown by 113a, and the user instruction indicator 111 from FIG. 2, changes to the word “chilled” 111a to notify the user that the beverage or wine is within the desired or optimal temperature range. The user instruction indicator 111a would be a second indicator or means to notify the user that the beverage or wine is within the desired or optimal temperature range.

FIG. 4 is a detail elevation view of one example of an embodiment of this invention illustrating such a temperature monitoring and indicator system 110 wherein the system is notifying the user that the temperature range of the wine in the bottle is too low (i.e. below the optimal range for that particular wine), and optimally needs to warm up before serving within the optimal temperature range.

FIG. 4 illustrates wine glass 112, crown indicator 116, and opaque bottom portion 113b of the interior cavity of the wine glass and the addition of the word “TOO” 117 as an indicator or instruction to the user that the beverage or wine within the bottle is below the optimal temperature range and is therefore “too chilled”.

It should be noted, and will be appreciated by those of ordinary skill in the art, that any words or other instructions or indicators may be utilized within the scope of embodiments of this invention. Important features of this invention are that there is a visible detectable change in the appearance of the temperature monitoring and indicator system or label, to alert or instruct the user whether the then real time or current temperature of the beverage is below, within or above the desired or optimal temperature range.

In the example of the embodiment illustrated in FIGS. 2-4, the various elements or indicators are preferably in different colors. For example, the wine glass may be white, the word “chill” in white, but when converted to the word “chilled”, the “ED” portion may be red in color. In FIG. 3 the fluid in the glass may go from transparent (such as in FIG. 2), to red in FIG. 3 to indicate that the wine in the bottle is within the desired or optimal temperature range. When the wine is below the desired temperature range, the word “Too” appears or changes from white or transparent to a color (preferably in blue color) to indicate to or alert the user that the wine needs to be warmed.

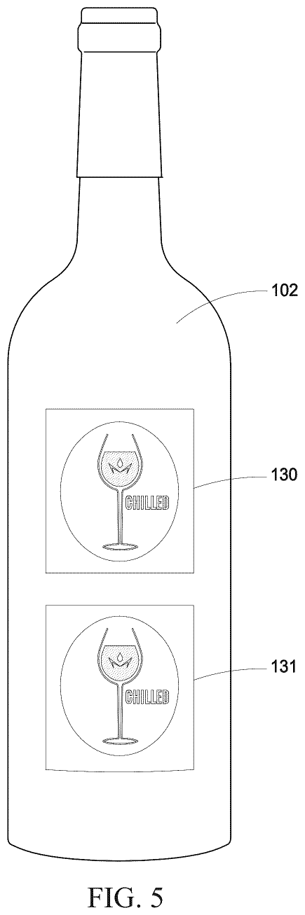

FIG. 5 is an elevation view of one example of an embodiment of this invention, illustrating two possible label-based temperature monitoring and indicator systems on a wine bottle, to illustrate different location possibilities and which may result in different temperatures being detected—i.e. a temperature differential from top to bottom. In some embodiments, but not all, it may be desirable to slightly alter the set temperature(s) for the temperature sensitive ink or material to compensate for the differential in temperatures that may occur in the temperature stratification of the liquid wine in the bottle.

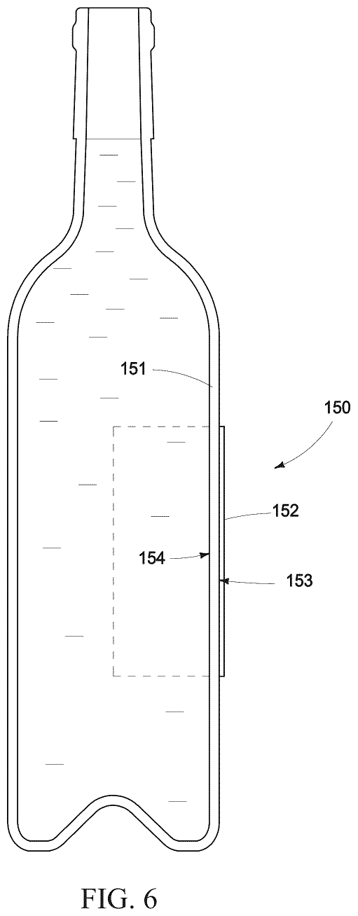

FIG. 6 is a detail elevation cross-section of the wall of the beverage container with a label thereon, illustrating a potential temperature delta or differential to be considered in establishing the predetermined temperature settings in the label at which the visible characteristics to the user change. FIG. 6 illustrates an embodiment of this temperature monitoring and indicator system 150, showing a cross-section of a beverage container wall 151, and wherein the temperature difference or delta between the liquid at the inner surface 154 within the beverage container and the monitoring label 152 on the outside 153 of the beverage container is considered in establishing the temperature at which the visible characteristics of the monitoring label change.

It should again be noted that the one or more temperature monitoring and indicators affixed to a wine bottle may be separate and independent from the existing or traditional label on the bottle, or may be integrated therewith, all within the scope of embodiments of this invention.

As will be appreciated by those of reasonable skill in the art, there are numerous embodiments to this invention, and variations of elements and components which may be used, all within the scope of this invention. In one embodiment for example, a temperature monitoring and notifying system for reflecting the temperature of wine within a wine bottle relative to a desired temperature for consuming the wine is disclosed, the system comprising: a substrate affixed to a beverage container; a first temperature sensitive ink affixed to or integral with the substrate, the first temperature sensitive ink being calibrated to change its appearance when a first desired temperature has been reached; and a second temperature sensitive ink affixed to or integral with the substrate, the second temperature sensitive ink being calibrated to change its appearance when a second desired temperature has been reached.

In addition to the embodiment disclosed in the preceding paragraph, the invention may include: further wherein the first temperature sensitive ink and the second temperature sensitive ink change to dissimilar appearances; further wherein the first temperature sensitive ink and the second temperature sensitive ink are single ink layers on the substrate; further wherein the first temperature sensitive ink is comprised of an ink first layer and an ink second layer placed partially or wholly on top of the ink first layer; further wherein the first temperature sensitive ink and the second temperature sensitive ink are each comprised of an ink first layer and an ink second layer; further wherein a second ink layer is placed on the substrate in a location different than the first ink layer; further wherein the beverage container is a wine bottle; further wherein the substrate is a paper-based substrate affixed to the beverage container; and/or further wherein the substrate is a resin-based substrate affixed to the beverage container.

In addition to the embodiments disclosed in the preceding two paragraphs, the invention may further comprise a method for monitoring and notifying the user when the approximated temperature of wine within a bottle is below, above or within a predetermined desired temperature range, comprising: providing a substrate affixed to a beverage container; affixing a first temperature sensitive ink affixed to or integral with the substrate, the first temperature sensitive ink being calibrated to change its appearance when a first desired temperature has been reached; and affixing a second temperature sensitive ink affixed to or integral with the substrate, the second temperature sensitive ink being calibrated to change its appearance when a second desired temperature has been reached.

In addition to the embodiment disclosed in the preceding paragraph, a method embodiment of the invention may be: further wherein the substrate is a paper-based substrate affixed to the beverage container; further wherein the substrate is a resin-based substrate affixed to the beverage container; and/or further wherein the first temperature sensitive ink is comprised of an ink first layer and an ink second layer placed partially or wholly on top of the ink first layer.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I/We claim:

1. A temperature monitoring and notifying system for reflecting the temperature of wine within a wine bottle relative to a desired temperature for consuming the wine, the system comprising:
a substrate affixed to a beverage container;
a first temperature sensitive ink affixed to or integral with the substrate, the first temperature sensitive ink being calibrated to change its appearance when a first desired temperature has been reached; and
a second temperature sensitive ink affixed to or integral with the substrate, the second temperature sensitive ink being calibrated to change its appearance when a second desired temperature has been reached.

2. The temperature monitoring and notifying system as recited in claim 1, and further wherein the first temperature sensitive ink and the second temperature sensitive ink change to dissimilar appearances.

3. The temperature monitoring and notifying system as recited in claim 1, and further wherein the first temperature sensitive ink and the second temperature sensitive ink are single ink layers on the substrate.

4. The temperature monitoring and notifying system as recited in claim 1, and further wherein the first temperature sensitive ink is comprised of an ink first layer and an ink second layer placed partially or wholly on top of the ink first layer.

5. The temperature monitoring and notifying system as recited in claim 1, and further wherein the first temperature sensitive ink and the second temperature sensitive ink are each comprised of an ink first layer and an ink second layer.

6. The temperature monitoring and notifying system as recited in claim 1, and further wherein a second ink layer is placed on the substrate in a location different than the first ink layer.

7. The temperature monitoring and notifying system as recited in claim 1, and further wherein the beverage container is a wine bottle.

8. The temperature monitoring and notifying system as recited in claim 1, and further wherein the substrate is a paper-based substrate affixed to the beverage container.

9. The temperature monitoring and notifying system as recited in claim 1, and further wherein the substrate is a resin-based substrate affixed to the beverage container.

10. A method for monitoring and notifying the user when the approximated temperature of wine within a bottle is below, above or within a predetermined desired temperature range, comprising:
providing a substrate affixed to a beverage container;
affixing a first temperature sensitive ink affixed to or integral with the substrate, the first temperature sensitive ink being calibrated to change its appearance when a first desired temperature has been reached; and
affixing a second temperature sensitive ink affixed to or integral with the substrate, the second temperature sensitive ink being calibrated to change its appearance when a second desired temperature has been reached.

11. A method for monitoring and notifying the user when the approximated temperature of wine within a bottle is below, above or within a predetermined desired temperature range as recited in claim 10, and further wherein the beverage container is a wine bottle.

12. A method for monitoring and notifying the user when the approximated temperature of wine within a bottle is below, above or within a predetermined desired temperature range as recited in claim 10, and further wherein the substrate is a paper-based substrate affixed to the beverage container.

13. A method for monitoring and notifying the user when the approximated temperature of wine within a bottle is below, above or within a predetermined desired temperature range as recited in claim 10, and further wherein the substrate is a resin-based substrate affixed to the beverage container.

14. The method for monitoring and notifying the user when the approximated temperature of wine within a bottle is below, above or within a predetermined desired temperature range as recited in claim 10, and further wherein the first temperature sensitive ink is comprised of an ink first layer and an ink second layer placed partially or wholly on top of the ink first layer.
